(19) United States
(12) Patent Application Publication
(10) Pub. No.: US 2011/0296667 A1
(43) Pub. Date: Dec. 8, 2011

(54) PROJECTOR MOUNT AND METHOD AND SYSTEM FOR INSTALLING A DEVICE IN A SUSPENDING CEILING

(76) Inventors: Jay Dittmer, Prior Lake, MN (US); Mike Warren, LeCenter, MN (US)

(21) Appl. No.: 13/153,010

(22) Filed: Jun. 3, 2011

Related U.S. Application Data
(60) Provisional application No. 61/351,523, filed on Jun. 4, 2010.

(51) Int. Cl. F16M 13/02; B23P 11/00

(52) U.S. Cl. 29/525.01; 248/343

(57) ABSTRACT

A system for installing a device in a suspended ceiling grid includes a device housing, and a frame adapted to be received in the suspended ceiling grid. The device housing is received in an aperture defined by the frame. A plurality of structures releasably secures the device housing to the frame. Embodiments of the invention provide simpler and more effective methods and systems for mounting ceiling mounted devices above a suspended ceiling such that the device can be installed in a minimal amount of time by one person.

### RELATED APPLICATIONS

This application claims the benefit of U.S. Provisional Patent Application Ser. No. 61/351,523, entitled PROJECTOR MOUNT AND METHOD AND SYSTEM FOR INSTALLING A PROJECTOR MOUNT IN A SUSPENDED CEILING, filed on Jun. 4, 2010, said application hereby fully incorporated herein by reference.

### FIELD OF THE INVENTION

The present invention relates to mounts, and more specifically, to methods and systems for mounting devices in a suspended ceiling.

### BACKGROUND OF THE INVENTION

The use of visual media in business settings has proliferated greatly in recent years due to the widespread availability and decreasing cost of visual projection systems. It is now common in commercial settings to have a projector, screen, or other visual media device more or less permanently installed in one or more conference or meeting rooms.

In some meeting room settings, it is desirable to have a projector, screen, or other media device that is always available for use, but that is concealed for security or aesthetic reasons when not in use. Consequently, automated lift devices have been developed that enable a projector to be selectively concealed above a suspended ceiling in a room. An example of one such prior art lift device is the SL-236SP SMART-LIFT Automated Projector Mount, made by Chief Manufacturing of Savage, Minn.

A drawback of mount devices such as the SL-236SP is that they can tend to be heavy and bulky, requiring at least two persons for installation in the room. Also, the installation can be time-consuming and difficult. Consequently, what is needed is a simpler and more effective method and system for mounting a projector above a suspended ceiling such that the projector mount can be installed in a minimal amount of time by one person.

Other media devices such as retractable screens can also advantageously be installed in suspended ceilings. Such devices can likewise be heavy or bulky, such that installation by one person can be difficult or impossible. What is needed is new methods and systems for installing such devices that enable installation by only one person without the need for assistance by others.

### SUMMARY OF THE INVENTION

The present invention meets the needs of the industry for a simpler and more effective method and system for mounting a projector or other ceiling mounted device above a suspended ceiling such that the mount or device can be installed in a minimal amount of time by one person.

In an embodiment, a system for installing a device in a suspended ceiling grid includes a device housing, and a frame adapted to be received in the suspended ceiling grid. The device housing is received in an aperture defined by the frame. A plurality of structures releasably secures the device housing to the frame. The plurality of structures for releasably securing the device housing to the frame may include at least one spring latch assembly. The system may further include a plurality of suspension wires for attaching the frame to an overhead structure. The system may also include a projector mount received in the device housing or a retractable screen received in the device housing.

In an embodiment a method of installing a device in a suspended ceiling grid includes inserting a frame in an aperture defined by the suspended ceiling grid, the frame defining a frame aperture, attaching the frame to an overhead structure with a plurality of suspension wires, inserting a device housing in the frame aperture, and latching the device housing to the frame. The method may further include disposing a device in the device housing after the device housing is latched to the frame. In embodiments of the invention, the step of latching the device housing to the frame comprises advancing the device housing through the frame aperture, thereby retracting a plurality of spring latches. In other embodiments, the step of latching the device housing to the frame comprises manually operating at least one latch attached to the device housing or the frame.

In an embodiment, a system for installing a device in a suspended ceiling grid includes a device housing, a frame adapted to be received in the suspended ceiling grid, the device housing received in an aperture defined by the frame, and means for releasably securing the device housing to the frame. The means for releasably securing the device housing to the frame may include a plurality of spring latch assemblies. In embodiments of the invention, each spring latch assembly may include a latch member operably coupled to the device housing and a biasing spring arranged to bias a portion of the latch member outwardly through an aperture in the device housing.

### BRIEF DESCRIPTION OF THE DRAWINGS

The embodiments of the present invention may be more completely understood in consideration of the following detailed description of various embodiments in connection with the accompanying drawings, in which:

FIG. 1 is a perspective view of a mount according to an embodiment of the invention depicted in a suspended ceiling grid;

FIG. 2 is view of the mount of FIG. 1 with a portion of the housing cutaway to show the lift assembly in the housing;

FIG. 3 is a perspective view of the frame portion of the mount of FIG. 1;

FIG. 4 is a fragmentary view of a spring latch portion of the mount of FIG. 1 engaged in a slot in the frame;

FIG. 5 is a fragmentary view of a grid interface member of the frame of the mount of FIG. 1 engaged with the ceiling grid;

FIG. 6 is a view of the housing and spring latch assembly of the mount of FIG. 1 with the side of the housing depicted in phantom to enable viewing of the spring latch;

FIG. 7 is a perspective view in which a frame of a system according to an embodiment of the invention is inserted in a ceiling grid during an initial stage of installation;

FIG. 8 is a perspective view in which the frame depicted in FIG. 7 is fully inserted in the ceiling grid;

FIG. 9 is a perspective view of the frame and ceiling grid of FIGS. 7 and 8 in a further stage of installation in which the frame is attached to an overhead structure with suspension wires;

FIG. 10 is a perspective view of the system depicted in FIGS. 7, 8 and 9 in a further stage of installation in which a device housing is inserted into the frame;

FIG. 11 is a perspective view in which the device housing depicted in FIG. 10 is fully inserted in the frame and ceiling grid;

FIG. 12 is a perspective view of the system of FIGS. 7-11 in a further stage of installation in which a cradle is inserted in the device housing;

FIG. 13 is a side elevation view of a spring latch assembly according to an embodiment of the invention;

FIG. 14 is a side elevation view of a slide latch assembly according to an alternative embodiment of the invention, in which the slide latch is depicted in an unlatched condition;

FIG. 15 is a side elevation view of the slide latch assembly of FIG. 14, in which the slide latch is depicted in a latched condition;

FIG. 16 is a perspective view of a rotating tab latch assembly according to an alternative embodiment of the invention, in which the rotating tab is depicted in an unlatched condition;

FIG. 17 is a perspective view of the rotating tab latch assembly of FIG. 16, in which the rotating tab is depicted in a latched condition;

FIG. 18 is a perspective view of a manual slide latch assembly according to an alternative embodiment of the invention, in which the slide latch is depicted in an unlatched condition;

FIG. 19 is a side elevation view of an alternative for securing the device housing to the frame using a fastener;

FIG. 20 is a side elevation view of another alternative for securing the device housing to the frame using a fastener;

FIG. 21 is a perspective view of a spring tab assembly according to an alternative embodiment of the invention;

FIG. 22 is a perspective view of the spring tab assembly of FIG. 21 in which a fastener secures the spring tab in position; and

FIG. 23 is a perspective view of a device housing and retractable screen assembly according to an embodiment of the invention.

While the present invention is amenable to various modifications and alternative forms, specifics thereof have been shown by way of example in the drawings and will be described in detail. It should be understood, however, that the intention is not to limit the present invention to the particular embodiments described. On the contrary, the intention is to cover all modifications, equivalents, and alternatives falling within the spirit and scope of the present invention as defined by the appended claims.

### DETAILED DESCRIPTION

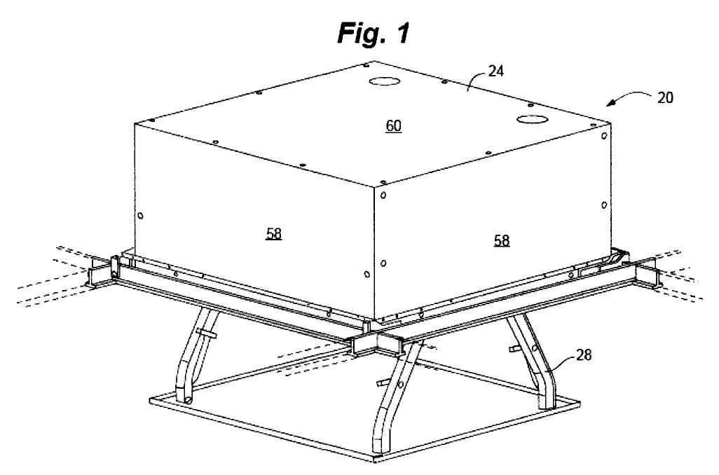

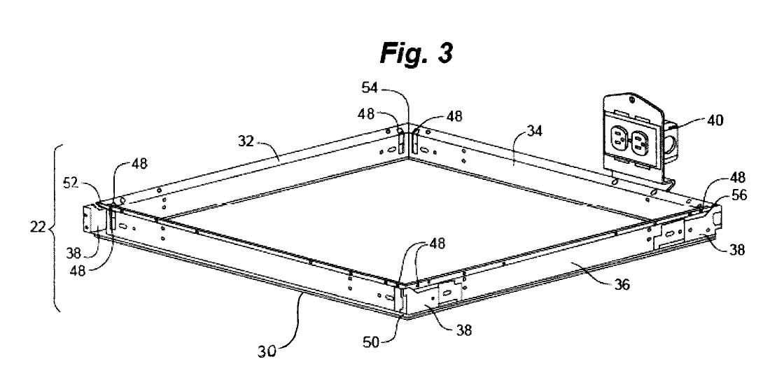

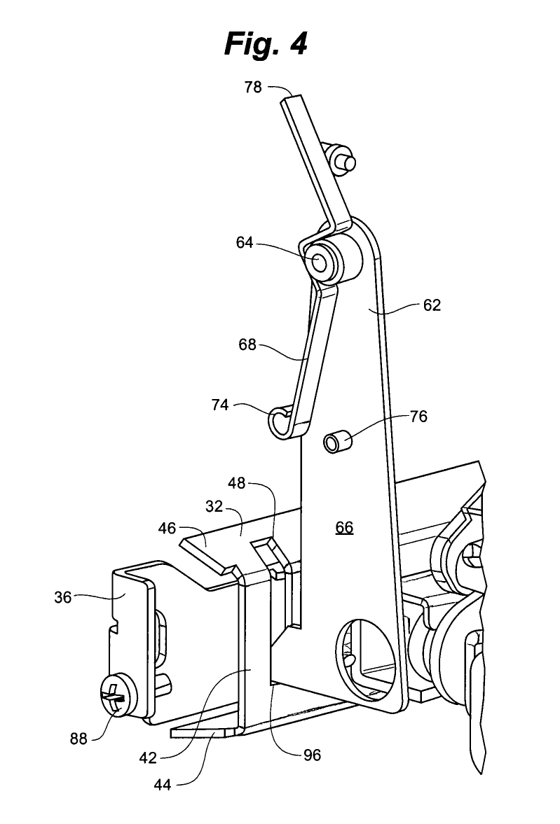

A projector mount 20 according to embodiments of the invention is depicted in FIGS. 1-12. Mount 20 generally includes ceiling grid interface frame 22, mount housing 24, lift assembly 26, and cradle 28. As depicted in FIG. 3, frame 22 generally includes rails 30, 32, 34, 36, grid member interfaces 38, and optionally electrical receptacle attachment 40. Each of rails 30, 32, 34, 36, includes a vertical web portion 42 and outwardly extending flange portions 44, 46. Vertical slots 48 are defined in each rail proximate corners 50, 52, 54, 56, of frame 22. Grid member interfaces 38 are attached to the outside faces of web portions 42 of rails 32, 36, at each end of the rail.

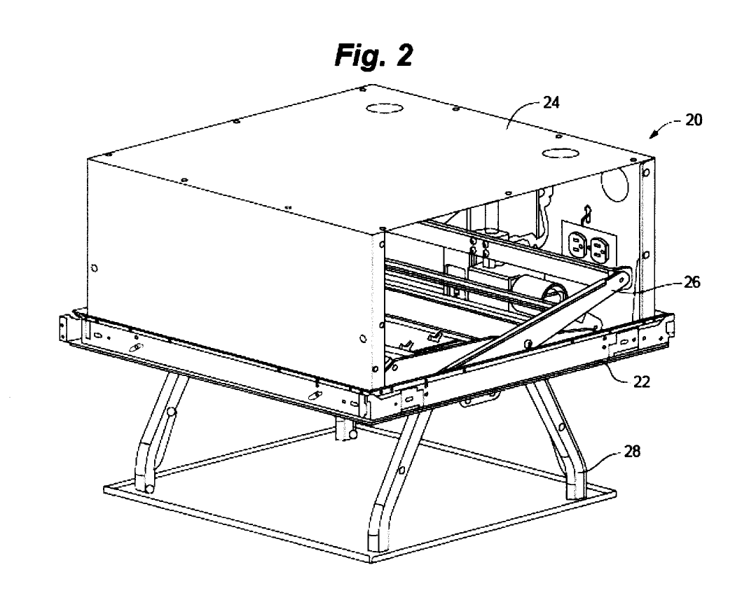

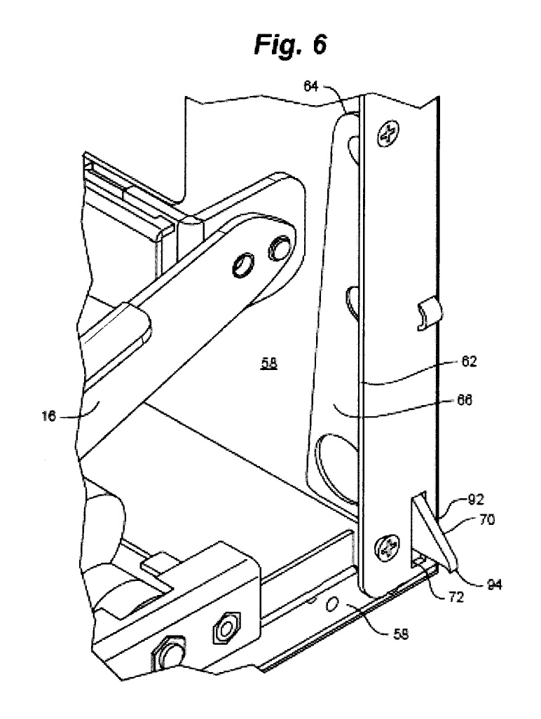

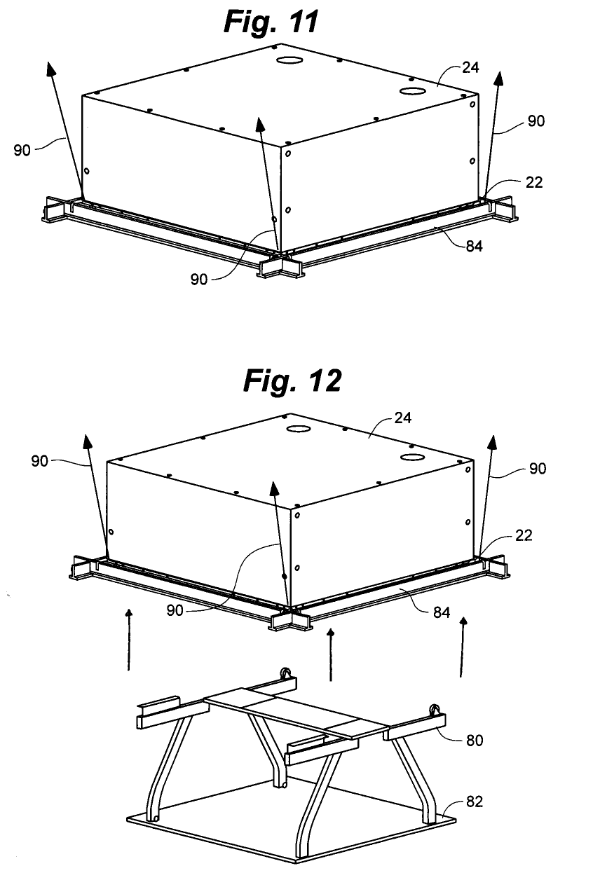

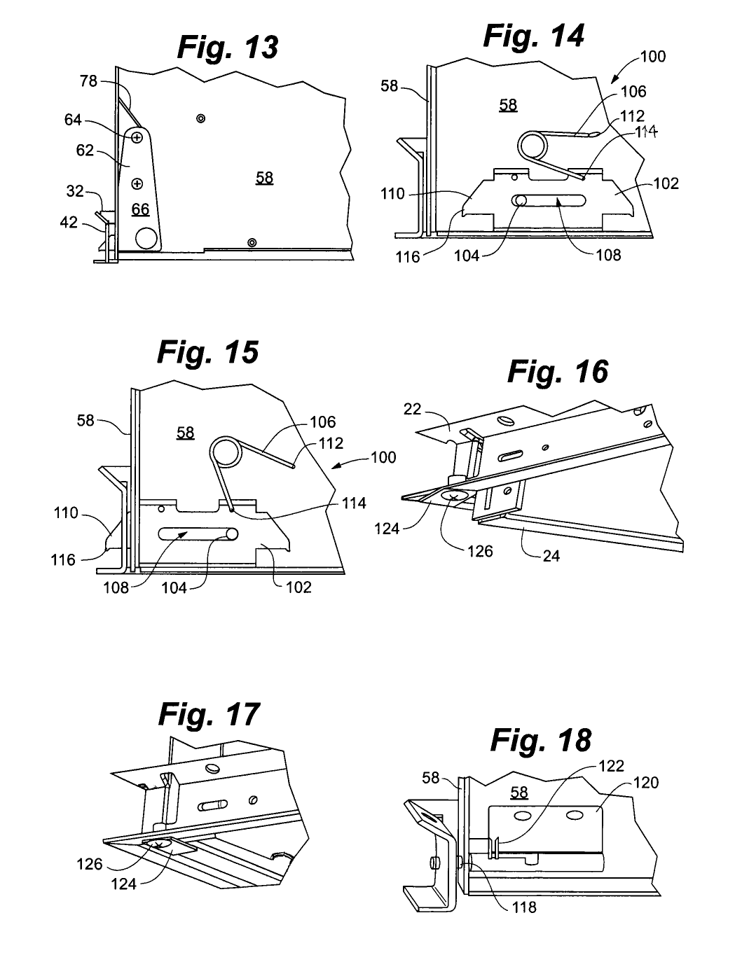

Mount housing 24 generally includes a plurality of side panels 58, and a top panel 60. Each spring latch assembly 62 generally includes L-shaped latch body 66 and biasing spring 68. As depicted in FIGS. 6 and 13, spring latch assemblies 62 are pivotally coupled to the inside face of sides 58 at pivots 64, with lower arm portion 70 of body 66 extending outward through aperture 72 in side panel 58. Loop portion 74 of spring 68 engages over post 76 of body 66, while free end 78 bears against side panel 58 to bias lower arm portion 70 in an outward direction through aperture 72. Lift assembly 26 is received in the enclosure formed by housing 24 as depicted in the cutaway view of FIG. 2, and is operably coupled to the housing 24.

Cradle 28 generally includes frame 80 and ceiling panel portion 82. Cradle 28 is coupled to lift assembly 26 such that cradle 28 is selectively extendable through the open bottom of housing 24 upon operation of lift assembly 28. Ceiling panel portion 82 effectively closes the open bottom of housing 24 when the lift assembly 26 is fully retracted.

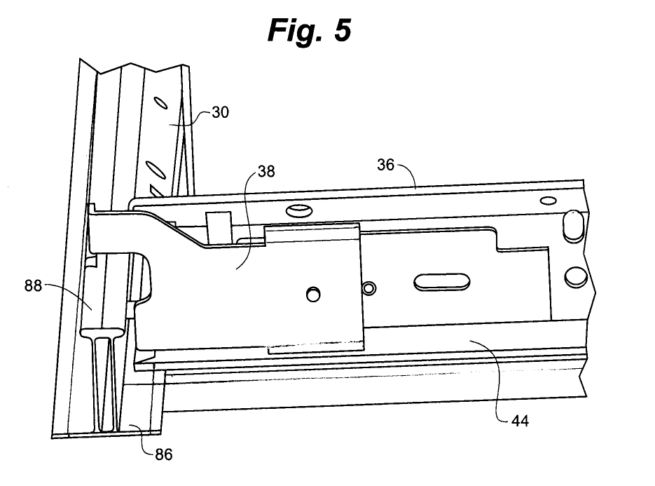

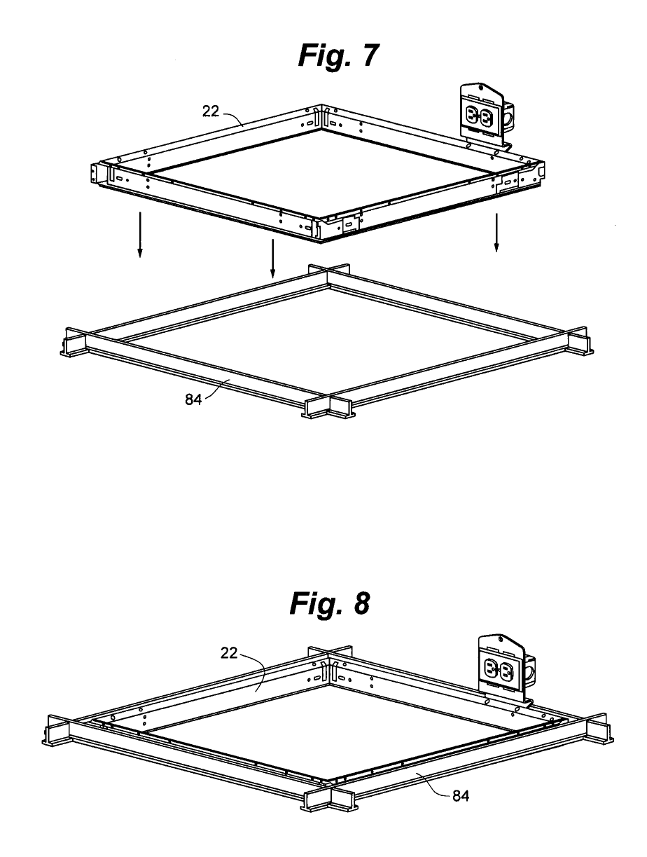

The various installation steps for installing mount 20 in a suspended ceiling grid 84 are depicted in FIGS. 7-12. First, as depicted in FIG. 7, frame 22 is set downward into grid 84 from above. Bottom flanges 44 of rails 30, 32, 34, 36, rest on lower flanges 86 of the grid members, and grid member interfaces 38 extend over upper flanges 88 of the grid members as depicted in FIG. 5. With frame 22 received in grid 84 as depicted in FIG. 8, fasteners 88 in grid member interfaces 38 can be tightened to secure frame 22 to grid 84.

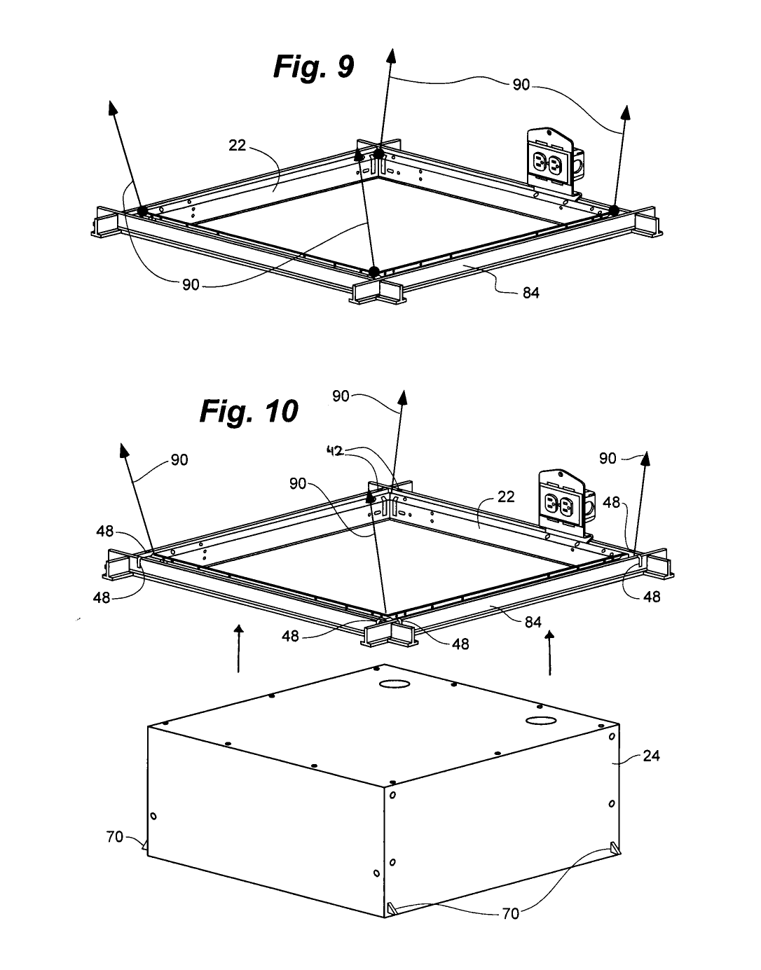

Next suspension wires 90 are attached to frame 22 as depicted in FIG. 9, and secured to the overhead roof or floor structure to provide load bearing support for mount 20 separate from the suspension members for grid 84. With frame 22 secured in grid 84 and supported with wires 90, housing 24 is inserted upward through frame 22 as depicted in FIG. 10. As the angled upper edge 92 of lower arm portion 70 of each spring latch 62 encounters lower flange 44 of the frame rails, body 66 is urged inward against the bias of spring 68. Once outer tips 94 of lower arm portions 70 reach the bottom ends 96 of slots 48, lower arm portions 70 snap into slots 48, urged by springs 68, thereby securing housing 24 to frame 22 and grid 84 as depicted in FIG. 11. Cradle 28 can then be secured to lift assembly 26 in housing 24 as depicted in FIG. 12 to complete the installation.

It will be appreciated that the system and method of the present invention can advantageously provide significant installation time savings, installing up to 10 times faster than previous mount systems. Further, because of the modular configuration of mount 20, with separate frame 22, housing 24, and cradle 28, the system may be installed by one person using only one ladder. Due to the lighter weight of each component lift afforded by the modular configuration, no floor lifting device is generally needed for the installation.

It will also be appreciated that other latching arrangements can be substituted for spring latch 62 within the scope of the present invention. Embodiments including such alternative latching arrangements are depicted in exemplary fashion in FIGS. 14-22. In FIGS. 14 and 15, slide latch assembly 100 generally includes slide 102, guide post 104, and spring 106. Slide 102 defines guide slot 108 and latch tongue 110. Slide 102 is slidably mounted on side 58 with guide post 104 extending through guide slot 108. Spring 106 has first end 112 fixed to side 58 and second end 114 coupled to slide 102 to bias slide 102 toward the latched position depicted in FIG. 15. When in the latched position of FIG. 15, latch tongue 110 extends outward through aperture 72 in side 58 to secure housing 24 to frame 22. Slide 102 can be retracted against the bias of spring 106 to enable tip 116 to pass lower flange 44 of the frame rails as housing 24 is inserted into frame 22. Once tip 116 reaches the bottom end 96 of slot 48, latch tongue 110 snaps into slot 48, urged by spring 106, thereby securing housing 24 to frame 22 and grid 84. A similar slide latch arrangement is depicted in FIG. 18, except that slide 118 is retained and is slidable in guide 120 on side 58. In the depicted embodiment of FIG. 18, slide 118 is manually actuated rather than spring loaded, and accordingly has actuation handle 122 to enable slide 118 to be shifted back and forth during installation.

In FIGS. 16 and 17, rotating tab 124 is pivotally attached to frame 22 at pivot 126. Tab 124 can be rotated out of the way as depicted in FIG. 16 to enable insertion of housing 24 into frame 22. Once housing 24 is in place, tab 124 can be rotated to secure housing 24 as depicted in FIG. 17.

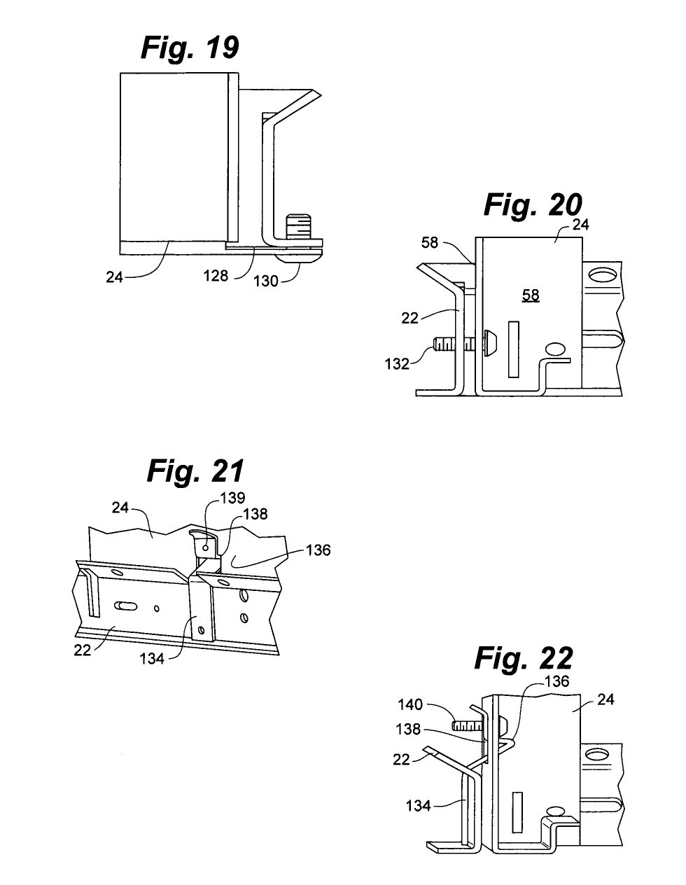

In FIG. 19, housing 24 has outwardly extending flange 128. Housing 24 can be secured to frame 22 with a fastener 130 such as a screw extending through an aperture (not depicted) defined in flange 128. In FIG. 20, housing 24 is secured to frame 22 with a screw 132 through an aperture (not depicted) in side 58.

In FIGS. 21 and 22, spring clip 134 is attached to frame 22 and has tongue portion 136. Aperture 138 is defined in side 58 to receive tongue portion 136, and thereby latch housing 24 to frame 22. Optionally, spring clip 134 can define aperture 139 for receiving a screw 140 to prevent unintended disengagement of tongue portion 136 from aperture 138.

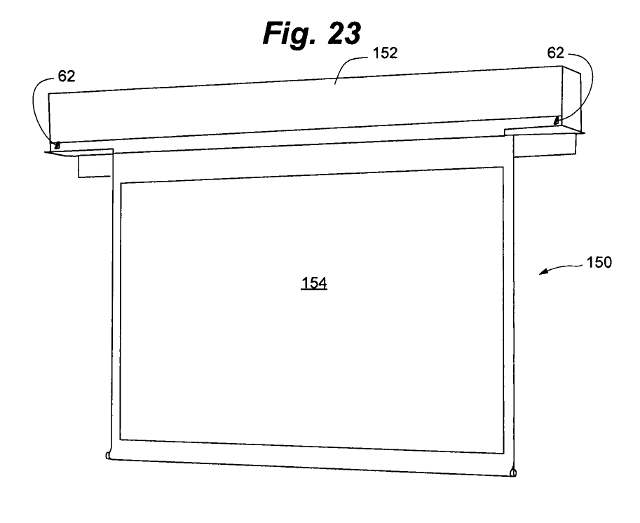

It will be further appreciated that embodiments of the invention may enable installation of other ceiling mounted devices, such as retractable viewing screen enclosures and the like. For example, a retractable screen assembly 150 including a screen 152 and housing 154 is depicted in FIG. 23. Housing 154 is equipped with spring latch assemblies 62 to enable housing 154 to be easily snapped into a suitable frame (not depicted) similar to frame 22 described hereinabove to thereby enable retractable screen assembly 150 to be easily installed in a suspended ceiling by one person working alone.

The foregoing descriptions present numerous specific details that provide a thorough understanding of various embodiments of the invention. It will be apparent to one skilled in the art that various embodiments, having been disclosed herein, may be practiced without some or all of these specific details. In other instances, known components have not been described in detail in order to avoid unnecessarily obscuring the present invention. It is to be understood that even though numerous characteristics and advantages of various embodiments are set forth in the foregoing description, together with details of the structure and function of various embodiments, this disclosure is illustrative only. Other embodiments may be constructed that nevertheless employ the principles and spirit of the present invention. Accordingly, this application is intended to cover any adaptations or variations of the invention. It is manifestly intended that this invention be limited only by the following claims and equivalents thereof.

Any incorporation by reference of documents above is limited such that no subject matter is incorporated that is contrary to the explicit disclosure herein. Any incorporation by reference of non-priority documents above is further limited such that no claims included in the documents are incorporated by reference herein and any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A system for installing a device in a suspended ceiling grid, the system comprising:
a device housing;
a frame adapted to be received in the suspended ceiling grid, the device housing received in an aperture defined by the frame; and
a plurality of structures for releasably securing the device housing to the frame.

2. The system of claim 1, wherein the plurality of structures for releasably securing the device housing to the frame includes at least one spring latch assembly.

3. The system of claim 1, further comprising a plurality of suspension wires for attaching the frame to an overhead structure.

4. The system of claim 1, further comprising a projector mount received in the device housing.

5. The system of claim 1, further comprising a retractable screen received in the device housing.

6. The system of claim 1, wherein the device housing comprises a plurality of side walls.

7. A method of installing a device in a suspended ceiling grid comprising:
inserting a frame in an aperture defined by the suspended ceiling grid, the frame defining a frame aperture;
attaching the frame to an overhead structure with a plurality of suspension wires;
inserting a device housing in the frame aperture; and
latching the device housing to the frame.

8. The method of claim 7, further comprising disposing a device in the device housing.

9. The method of claim 7, wherein the step of latching the device housing to the frame comprises advancing the device housing through the frame aperture, thereby retracting a plurality of spring latches.

10. The method of claim 7, wherein the step of latching the device housing to the frame comprises manually operating at least one latch attached to the device housing or the frame.

11. A system for installing a device in a suspended ceiling grid, the system comprising:
a device housing;
a frame adapted to be received in the suspended ceiling grid, the device housing received in an aperture defined by the frame; and
means for releasably securing the device housing to the frame.

12. The system of claim 1, wherein the means for releasably securing the device housing to the frame comprises a plurality of spring latch assemblies.

13. The system of claim 12, wherein each spring latch assembly comprises a latch member operably coupled to the device housing and a biasing spring arranged to bias a portion of the latch member outwardly through an aperture in the device housing.

14. The system of claim 11, further comprising a plurality of suspension wires for attaching the frame to an overhead structure.

15. The system of claim 11, further comprising a projector mount received in the device housing.

16. The system of claim 11, further comprising a retractable screen received in the device housing.

17. The system of claim 11, wherein the device housing comprises a plurality of side walls.
